(19) United States
(12) Patent Application Publication
(10) Pub. No.: US 2023/0221712 A1
(43) Pub. Date: Jul. 13, 2023

(54) A METHOD AND AN APPARATUS FOR ENABLING ACCESS TO PROCESS DATA OF A FOOD PRODUCTION PLANT

(71) Applicant: Tetra Laval Holdings & Finance S.A., Pully (CH)

(72) Inventors: Sebastian Nygren, Arlöv (SE); Rickard Moberg, Teckomatorp (SE); Mattias Abrahamsson, Annelöv (SE)

(21) Appl. No.: 18/000,924

(22) PCT Filed: May 28, 2021
(86) PCT No.: PCT/EP2021/064408

§ 371 Date: Dec. 6, 2022

(30) Foreign Application Priority Data
Jun. 12, 2020 (EP) 20179799.0

(51) Int. Cl. G05B 19/418

(52) U.S. Cl. CPC G05B 19/41885; G05B 19/4183

(57) ABSTRACT

A method for enabling access to process data for a food production plant can include receiving, by a central server, properties of the food production plant from the control system, generating a data model based on the properties, said data model comprising data model properties, wherein the data model is control system type independent, transmitting the data model properties to an application programming interface (API), receiving adapted data model properties from the API, updating the data model based on the adapted data model properties, receiving, by the central server, plant design data from a plant design tool, generating an API based on the data model and the plant design data, and transmitting the API to a monitoring device, thereby providing for that the monitoring device is enabled to receive the process data from the food production plant.

### TECHNICAL FIELD

The invention relates to software technology within the food processing industry. More particularly, it is related to methods and apparatuses for enabling access to process data of a food production plant.

### BACKGROUND ART

Today, within the food production industry, systems, such as supervisory control and data acquisition (SCADA) systems, are often used to control the equipment of the food production plant. For a SCADA system to run and control the plant, it is dependent on data describing all equipment and their corresponding properties. For instance, for a tank, properties such as volume, inlets, outlets and valves connected to these are often needed to use the SCADA systems.

Many plants rely on the same type of equipment but with different setups and with customizations specific to a single plant. Because of these differences, a data model representing the plant is required to be customized for each plant which in turn yields high engineering costs. This engineering costs also increase due to that there are several different types of control systems resulting in that control system adaptations often are necessary.

The general solution to this problem today is to make database models that reflect the customizations needed for a specific installation. The engineer would then write scripts to retrieve this data targeting a unique database scheme. This process is however time consuming and also increases the risk of bugs being introduced.

### SUMMARY

It is an object of the invention to at least partly overcome one or more of the above-identified limitations of the prior art. In particular, it is an object to provide a method for enabling cost-efficient and easier data retrieval from a food production plant by dynamically generating an API without altering the control system of the food production plant.

It has been realized that by automatically generating an API, a higher accessibility of process data can be achieved. This may be beneficial to for instance human-machine interface (HMI) developers when they develop a monitoring system of the food processing plant.

To provide for that different types of control systems can be managed efficiently, it has been realized that a digital model, also referred to as data model, may be formed based on properties of the food production plant retrieved via the control system. To avoid a control system type dependency, the properties are transformed into data model properties based upon which the data model is built. Thus, if using a central server for hosting the data model, it is enough that a software used in the central server for transforming the properties to the data model properties are made to support the different types of control systems.

Further, it has also been realized that by combining the data model properties, which originates from the properties from the food production plant, with plant design data, that is, information related to a process design of the production plant often made by a processing engineer, the API may be built to comprise most or all information needed for an HMI developer when developing an HMI application. For instance, with the suggested approach, smart search functions can provide available alternatives during development.

According to a first aspect it is provided a method for enabling access to process data of a food production plant controlled by a control system, said method comprising

receiving, by a central server, properties of the food production plant from the control system,

generating a data model based on the properties, said data model comprising data model properties, wherein the data model is control system type independent,

transmitting the data model properties to an application programming interface (API) tool,

receiving adapted data model properties from the API tool,

updating the data model based on the adapted data model properties,

receiving, by the central server, plant design data from a plant design tool,

generating an API based on the data model and the plant design data, and

transmitting the API to a monitoring device, thereby providing for that the monitoring device is enabled to receive the process data from the food production plant.

As explained above, by having the central server, the data model may be formed based on the properties from the control system and by doing so the control system dependency can be avoided, providing for that amount time needed for setting up a new installation can be reduced, and since less customization is needed, a risk of errors during installation can also be reduced.

By providing a possibility to adapt the data model properties, a dynamic approach is achieved. Put differently, the API may be made to fit the needs and thereby avoiding high engineering costs.

Further, by including the plant design data, information from several sources may be combined when forming the API, which provides for that a risk that the HMI developer, or other person using the API, is lacking information can be reduced.

Herein the term “process data”should be understood to include both parameter values, such as temperature, flow rate, turbulence etc. gathered by sensors in different parts of the plant, as well as configuration data, that is, how the plant or part of the plant is currently configured to operate, e.g. which tanks that are used for holding product and which tanks that are cleaned. The configuration data can be retrieved from e.g. valves, control units, such as PLCs, or the control system. In this way, it is made possible to create HMI applications in which both configuration data and/or parameter values are included and presented on a screen. It is also possible to receive user input via the HMI application that can be used for changing the parameter values and/or the configuration data.

The API may provide for that the monitoring device is configured to receive the process data directly from at least one sensor of the food production plant.

If all process data is to be sent via the control system, there is a risk that information made available via the sensors in the food production plant does not reach the HMI developer. For instance, the control system may not support switching time for a valve and by not supporting this, the information cannot reach the HMI engineer. However, if the process data may be retrieved directly from the sensors, i.e. by bypassing the control system, the HMI engineer are not restricted by limitations in the control system. To provide for that the process data can be retrieved directly from the sensors, information on the sensors may be retrieved via the plant design data and/or via the API tool.

The process data can be sensor data inaccessible to the control system.

The control system may be a supervisory control and data acquisition (SCADA) system.

The monitoring device may be a human-machine interface (HMI) device.

The data model may be control system programming language independent.

The step of generating the API based on the adapted data model properties may comprise the sub-steps of

generating source code,

compiling the source code into a binary file.

The step of generating the API based on the adapted data model properties may comprise the sub-step of

generating API documentation.

According to a second aspect it is provided a central server for enabling access to process data of a food production plant controlled by a control system, wherein the central server is communicatively connected to the food production plant via the control system, to an API tool, to a plant design tool and to a monitoring device, said central sever comprising a memory, a processor and a transceiver,

said transceiver being configured to

receive properties of the food production plant from the control system,

transmit the data model properties to the API tool,

receive adapted properties from the API tool,

receive plant design data from the plant design tool,

transmit the API to the monitoring device,

said processor and memory being configured to execute

a data model generation function configured to generate a data model based on the properties, said data model comprising data model properties, wherein the data model is control system type independent,

a data model update function configured to update the data model based on the adapted data model properties,

an API generation function configured to generate the API based on the data model and the plant design data.

The API may provide for that the monitoring device is configured to receive the process data directly from sensors in the production plant.

The process data may be sensor data inaccessible to the control system.

The control system may be a supervisory control and data acquisition (SCADA) system.

The monitoring device may be a human-machine interface (HMI) device.

According to a third aspect it is provided a food production plant comprising

a number of food production units,

a control system communicatively connected to sensors in the food production units,

a central server according to the second aspect,

an API tool configured to generate adapted data model properties based on the data model properties,

a plant design tool configured to provide plant design data, and

a monitoring device configured to receive process data from the sensors in the food production units, wherein a software of the monitoring device is configured by using the API.

According to a fourth aspect it is provided a computer program comprising instructions for implementing a method according to a first aspect.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1 is a schematic view of a food production plant comprising a control system, a central server and a monitoring device.

FIG. 2 is a flowchart illustrating the steps of a method for enabling access to process data of the food production plant.

FIG. 3 illustrates the central server in further detail.

### DETAILED DESCRIPTION

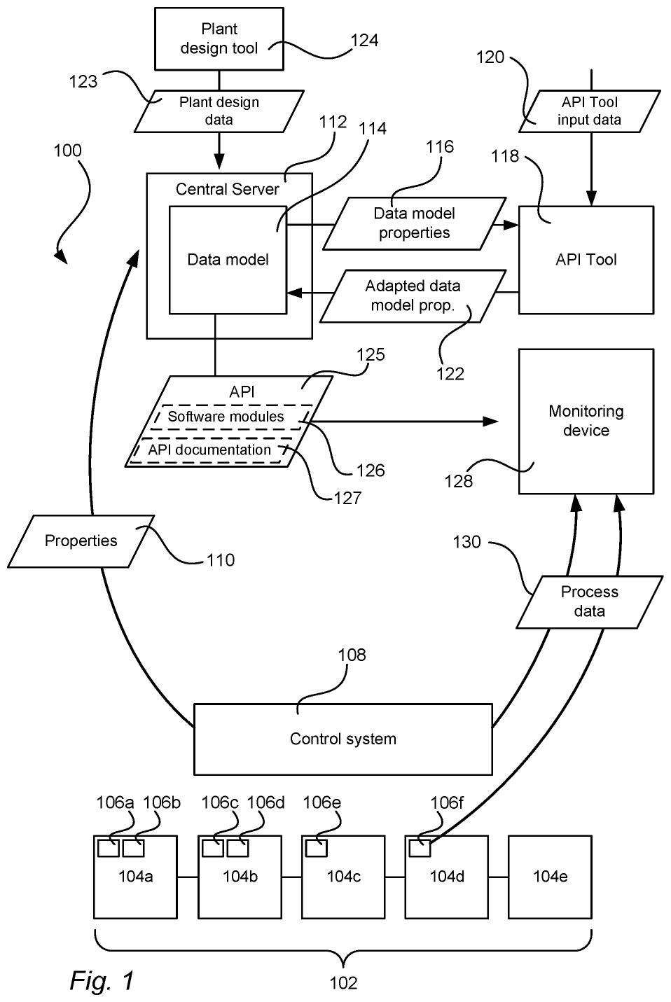

FIG. 1 illustrates an overview of a food production plant 100 by way of example.

In this example, a food production line 102 comprising a number of food production units 104a-e is provided. However, even though not illustrated, the food production plant 100 may also comprise a number of lines or a network of food production units 104a-e connected to each other via valve batteries.

The food production units 104a-e can comprise programmable logic controllers (PLCs) and a number of sensors 106a-f. As illustrated, several sensors may be provided in one and the same food production unit and there may also be food production units without sensors. In this context, the food production units should be given a broad meaning and may also include e.g. pipes, valves or packaging equipment.

The food production units 104a-e can be controlled by a control system 108 that is communicatively connected to the food production units 104a-e. Via the control system 108, properties 110 of the food production plant 100, or more specifically the food production units 104a-e, can be provided to a central server 112.

The central server 112 is herein illustrated as a part of the food production plant. The central server can however also be shared between multiple food production plants. In the case of a shared central server, information between the different food production plants can be shared.

Based on the properties 110, a data model 114 can be formed. The data model can be seen as a digital model of the food production plant 100, that is the food production units 104a-e. To provide for increased efficiency, the data model may be control system type independent, that is, software configured for creating the data model based on the properties can be made to translate different programming languages, different architecture etc into a common format. The properties can also be so called input-output (IO) properties, also referred to as parameters.

Data model properties 116, being part of the data model 114, may be transferred from the central server 112 to an application programming tool (API) tool 118. The API tool 118 may be separated from the central server 112, but it may also share the same hardware as the central server in full or in part. An advantage with the API tool 118 is that the data model properties 116 may be adapted in accordance with needs and requirements related to how an API to be developed is intended to be used. These needs and requirements may be reflected in API tool input data 120 that is input to the API tool 118. This input may be provided by a user via a user interface.

Based on the API tool input data 120, adapted data model properties 122 can be formed and transmitted back to the central server 112. However, as an alternative, the API tool input data 120 may be sent to the central server directly such that the adapted data model properties can be formed in the central server.

In addition to the adapted data model properties 122, plant design data 123 can be received by the central server 112. The plant design data 123 can be provided from a plant design tool 124, which may be a tool used by process engineers for designing the food production plant 100. The plant design data 123 may be provided before the data model properties are transmitted to the API tool, and hence the plant design data 123 may be reflected in the data model properties 116 transmitted to the API tool 118.

Using both the adapted data model properties 122 and the plant design data 123, an API 125 may be formed. The API 125 may comprise software modules 127 and API documentation 127, that is, text data describing the software modules, both being automatically generated in the central server 112.

The API 125 can be provided to a monitoring device 128 such that e.g. HMI applications can be developed in which process data 130 from the food production plant 100 is used. In addition to being an HMI device, such as a touch display, the monitoring device can be personal computer using a spreadsheet-based software, such as Microsoft Excel™, in which the process data 130 is continuously being monitored.

As illustrated, the process data 130 may be provided to the monitoring device 130 via the control system or directly from one or several of the sensors 106a-f to the monitoring device. An advantage of having the option to by-pass the control system is that in case the control system 108 does not support that the process data 130, or part of the process data 130, is sent via the control system 108, this can still be possible when having the possibility to by-pass.

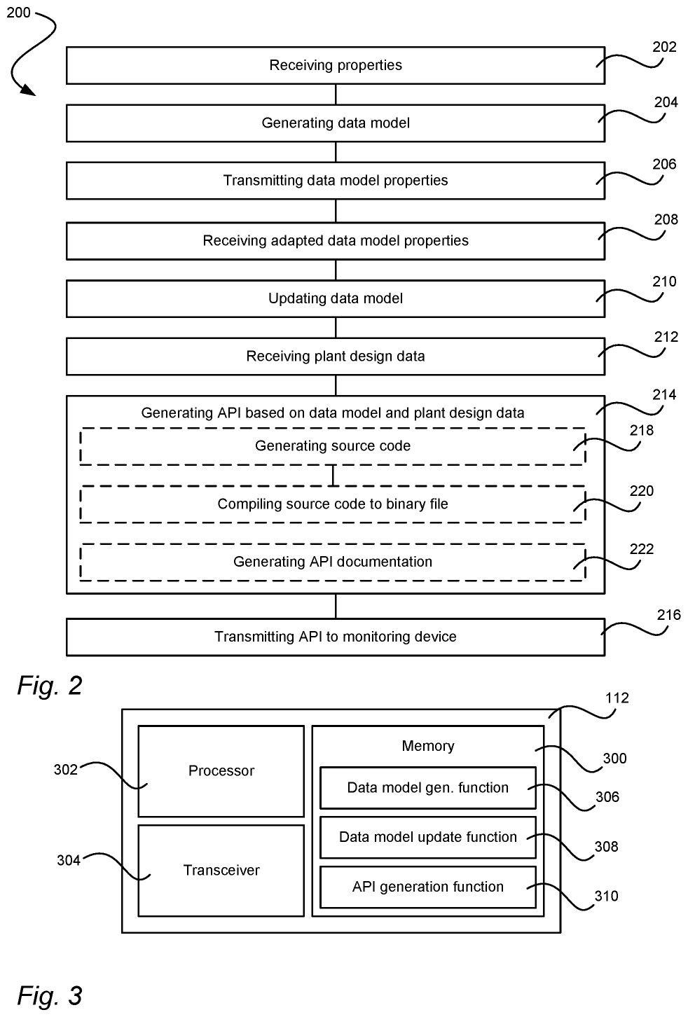

FIG. 2 is a flow chart 200 illustrating a method for enabling access to the process data 130 of the food production plant 100 controlled by a control system 108.

In a first step 202, the properties 110 of the food production plant 100 can be received.

In a second step 204, the data model 114 can be generated based on the properties 110. The data model 114 may comprise the data model properties 116 and the data model 114 may be control system type independent.

In a third step 206, the data model properties 116 can be transmitted to the API tool 118.

In a fourth step 208, the adapted data model properties 122 can be received from the API tool 118.

In a fifth step 210, the data model 114 can be updated based on the adapted data model properties 122.

In a sixth step 212, the plant design data 123 from the plant design tool 124 can be received by the central server 112.

In a seventh step 214, the API 125 can be generated based on the data model 114 and the plant design data 123.

In an eighth step 216, the API 125 can be transmitted to the monitoring device 128, thereby providing for that the monitoring device 128 is enabled to receive the process data 130 from the food production plant 100.

Optionally, the seventh step 214 may comprise a ninth step 218 in which source code is generated, and a tenth step 220 in which the source code can be compiled into a binary file.

Optionally, in an eleventh step 222, which may be a sub-step of the seventh step 214, API documentation can be generated.

Even though described in a certain order, the steps may be performed in other orders as well.

FIG. 3 illustrates the central server 112 in further detail. As illustrated, the central server 112 may comprise a memory 300, a processor 302 and a transceiver 304.

The transceiver 304 may be configured to receive the properties 110 of the food production plant 100 from the control system 108, transmit the data model properties 116 to the API tool 118, receive the adapted properties 122 from the API tool 118, receive the plant design data 123 from the plant design tool 124, and transmit the API 125 to the monitoring device 128.

The processor 302 and the memory 300 can be configured to execute a data model generation function 306 configured to generate a data model based on the properties 110, a data model update function 308 configured to update the data model 114 based on the adapted data model properties 122, an API generation function 310 configured to generate the API 125 based on the data model 114 and the plant design data 123.

From the description above follows that, although various embodiments of the invention have been described and shown, the invention is not restricted thereto, but may also be embodied in other ways within the scope of the subject-matter defined in the following claims.

1. A method for enabling access to process data of a food production plant controlled by a control system, said method comprising:
receiving, by a central server, properties of the food production plant rom the control system,
generating a data model based on the properties, said data model comprising data model properties, wherein the data model is control system type independent,
transmitting the data model properties to an application programming interface (API) tool,
receiving adapted data model properties from the API tool,
updating the data model based on the adapted data model properties,
receiving, by the central server, plant design data from a plant design tool,
generating an API based on the data model and the plant design data, and
transmitting the API to a monitoring device, thereby providing for that the monitoring device is enabled to receive the process data from the food production plant.

2. The method according to claim 1, wherein the API provides for that the monitoring device is configured to receive the process data directly from at least one sensor of the food production plant.

3. The method according to claim 2, wherein the process data is sensor data inaccessible to the control system.

4. The method according to claim 1, wherein the control system is a supervisory control and data acquisition (SCADA) system.

5. The method according to claim 1, wherein the monitoring device is a human-machine interface (HMI) device.

6. The method according to claim 1, wherein the data model is control system programming language independent.

7. The method according to claim 1, wherein generating the API based on the adapted data model properties comprises:
generating source code, and
compiling the source code into a binary file.

8. The method according to claim 1, wherein generating the API based on the adapted data model properties comprises:
generating API documentation.

9. A central server for enabling access to process data of a food production plant controlled by a control system, wherein the central server is communicatively connected to the food production plant via the control system, to an API tool, to a plant design tool and to a monitoring device, said central sever comprising a memory, a processor and a transceiver, said transceiver being configured to:
receive properties of the food production plant from the control system,
transmit data model properties to the API tool,
receive adapted properties from the API tool,
receive plant design data from the plant design too,
transmit the API to the monitoring device, and
said processor and memory being configured to execute;
a data model generation function configured to generate a data model based on the properties, said data model comprising data model properties, wherein the data model is control system type independent,
a data model update function configured to update the data model based on the adapted data model properties, and
an API generation function configured to generate the API based on the data model and the plant design data.

10. The central server according to claim 9, wherein the API provides for that the monitoring device is configured to receive the process data directly from sensors in the food production plant.

11. The central server according to claim 9, wherein the process data is sensor data inaccessible to the control system.

12. The central server according to claim 9, wherein the control system is a supervisory control and data acquisition (SCADA) system.

13. The central server according to claim 9, wherein the monitoring device is a human-machine interface (HMI) device.

14. A food production plant comprising:
a number of food production units,
a control system communicatively connected to sensors in the food production units,
a central server according to claim 9,
an API tool configured to generate adapted data model properties based on the data model properties,
a plant design tool configured to provide plant design data, and
a monitoring device configured to receive process data from the sensors in the food production units, wherein a software of the monitoring device is configured by using the API.

15. A non-transitory computer readable medium storing a computer program comprising instructions for implementing a method of claim 1.
